(19) United States
(12) Patent Application Publication
(10) Pub. No.: US 2003/0171518 A1
(43) Pub. Date: Sep. 11, 2003

(54) Branched copolymers based on unsaturated nitriles and on conjugated dienes

(76) Inventors: Hans Magg, Kurten (DE); Luigi Marinelli, Leverkusen (DE); Rolf Josten, Neuss (DE); Hans-Rafael Winkelbach, Brights Grove (CA)

Correspondence Address: BAYER POLYMERS LLC, 100 BAYER ROAD, PITTSBURGH, PA, 15205, US

(21) Appl. No.: 10/297,292

(22) PCT Filed: May 28, 2001
(86) PCT No.: PCT/EP01/05970

(30) Foreign Application Priority Data
Jun. 7, 2000 (DE) 10027768.3

(51) Int. Cl. C08F 20/42

(52) U.S. Cl. 526/297

(57) ABSTRACT

The present invention relates to branched copolymers based on unsaturated nitrites and conjugated dienes which are characterized in that the content of bonded unsaturated nitrile is 15 to 50 wt. %, the Mooney viscosity ranges from 15 to 150 MU [ML 1+4/100° C.], the chain branching ranges from 0 to 20° (determined by the Δδ_{B} value) and the solubility is ≧85 wt. % (measured in methyl ethyl ketone at 20° C.).

The copolymers according to the invention can be used for the preparation of hydrogenated copolymers based on unsaturated nitrites and conjugated dienes (HNBRs) for the production of all kinds of mouldings by the injection moulding or extrusion process and for improving the flowability of elastomers.

The present invention relates to branched copolymers based on unsaturated nitriles and conjugated dienes, to a process for the preparation thereof and to their use for the production of vulcanizates and for improving the flowability of elastomers and mixtures thereof, said elastomers being mixed with the copolymers according to the invention.

EP 0 779 300 B1 describes an unsaturated nitrile/conjugated diene copolymer containing at least 0.03 mol, per 100 mol of monomer units yielding the copolymer molecule, of an alkylthio group having 12 to 16 carbon atoms, which include at least 3 tertiary carbon atoms, and also having a sulfur atom bonded directly to at least one of the tertiary carbon atoms.

The copolymers described in EP 0 779 300 B1 have the high vulcanization rate necessary for the injection moulding process, and yield vulcanizates which have a good oil and cold resistance combined with a high mechanical strength.

Although the copolymers described in said European patent already possess improved processing properties, especially in the injection moulding process, it is desirable to provide copolymers based on unsaturated nitriles and conjugated dienes which can be processed substantially more easily, especially in the injection moulding process, i.e. have an improved flowability, and which furthermore yield vulcanizates whose properties are at a level which affords industrially useful mouldings.

It has now been found that copolymers based on unsaturated nitriles and conjugated dienes have a particularly good flow behaviour if there is a certain proportion of chain branchings in their molecule.

The present invention therefore provides branched copolymers based on unsaturated nitriles and conjugated dienes which are characterized in that the content of bonded unsaturated nitrile is 15 to 50 wt. %, the Mooney viscosity ranges from 15 to 150 MU [ML 1+4/100° C.], the chain branching ranges from 0 to 20° (determined by the Δδ_{B} value) and the solubility is ≧85 wt. % (measured in methyl ethyl ketone at 20° C.).

Preferred branched copolymers are those whose content of bonded unsaturated nitrile is 15 to 50 wt. %, whose Mooney viscosity ranges from 20 to 120 MU, whose chain branching ranges from 2 to 18° (determined by the Δδ_{B} value) and whose solubility is greater than 90 wt. % (measured in methyl ethyl ketone).

Very particularly preferred copolymers are those whose content of bonded unsaturated nitrile is 15 to 45 wt. %, whose Mooney viscosity ranges from 25 to 85 MU, whose chain branching ranges from 4 to 16° and whose solubility is greater than 95 wt. %.

The following may be mentioned as examples of unsaturated nitriles which can be used to synthesize the branched copolymers according to the invention: acrylonitrile, methacrylonitrile and α-chloroacrylonitrile. It is preferable to use acrylonitrile.

Examples of suitable conjugated dienes are 1,3-butadiene, 2,3-dimethylbutadiene, isoprene and 1,3-pentadiene, preferably 1,3-butadiene.

It is of course possible to add other copolymerizable monomers to said structural monomers, provided the desired properties of the branched copolymers are not altered. Suitable examples of said other monomers are monomers containing vinyl groups, such as styrene, α-methylstyrene and vinylpyridine, non-conjugated dienes such as vinylnorbornene, dicyclopentadiene and 1,4-hexadiene, unsaturated carboxylic acids such as acrylic and methacrylic acids and fumaric and maleic acids, unsaturated carboxylic acid esters such as methacrylates, ethylacrylates, methylmethacrylates, propylacrylates, propylmethacrylates, butylacrylates or 2-ethylhexylacrylates.

These copolymerizable monomers are conventionally added in amounts of up to 50 wt. %, based on the total amount of monomers used. It is of course possible to add said monomers individually or in a mixture with one another, with the proviso that the desired properties of the branched copolymers remain unaffected.

The copolymers based on unsaturated nitriles and conjugated dienes, according to the invention, have an average molecular weight (Mₙ) ranging from 2000 to 150,000, preferably from 4000 to 80,000 (determined by the thermal field flow fractionation (ThFFF) method). The average molecular weight (M_{w}) is 80,000 to 8,000,000, preferably 150,000 to 5,000,000 (determined by the ThFFF method).

The ratio M_{w}/Mₙ ranges from 3.5 to 250, preferably from 5.0 to 150.

The branched copolymers according to the invention are prepared by polymerizing the appropriate monomers in conventional manner by the emulsion process in the presence of a chain regulator or molecular weight regulator. It is important that the molecular weight regulator is not added to the polymerization mixture in a single batch, i.e. all at once, but in several stages. According to the invention, the molecular weight regulator is added in at least two stages, preferably three or more stages. It is even possible to add the molecular weight regulator continuously over the whole of the polymerization time. Thus, for a two-stage operation, the molecular weight regulator can first be added in amount of 5 to 65%, preferably of 10 to 60%, based on the total amount of regulator, before polymerization begins, and the remainder of the molecular weight regulator can be added later when the conversion is 5 to 80%, preferably 10 to 55%, based on the total amount of monomers used.

In the case of a three-stage or multiple-stage addition, it is recommended to carry out appropriate preliminary experiments in order to determine the most favourable amount of molecular weight regulator and the most favourable time to add it, it always being necessary to ensure that the above-mentioned specification of the copolymers according to the invention is observed.

As stated, the polymerization is conventionally carried out in emulsion with the conventional emulsifiers (0.05 to 10 parts by weight per 100 parts by weight of monomers, preferably 0.5 to 3 parts by weight per 100 parts by weight of monomers) based e.g. on fatty acids, fatty acid esters or fatty acid salts, in the presence of a free radical generator (initiator), for example organic or inorganic peroxides, at temperatures ranging from approx. 5 to 100° C. Other emulsifiers which may be mentioned are those based on rosin acids (disproportionated or hydrogenated), sulfonates (aliphatic or aromatic), sulfates (aliphatic or aromatic) or non-ionic surfactants.

A general method of preparing copolymers based on unsaturated nitriles and conjugated dienes in emulsions is described in greater detail e.g. in the European patent cited above, to which reference is made here.

The copolymers according to the invention can be prepared using a very wide variety of chain regulators, such as those described in EP 0 779 300 B1, page 3, lines 51-58. Other chain regulators or molecular weight regulators are mentioned in paragraph 3, page 4, of the same patent. Alkylthiols, such as 2,4,4-trimethylpentane-2-thiol, 2,2′,4,6,6′-pentamethylheptane-4-thiol, 2,2′,4,6,6′,8,8′-heptamethylnonane-4-thiol and mixtures thereof, may be singled out in particular.

Said chain regulators are used in the polymerization of the monomers in amounts of 0.05 to 3 wt. %, preferably of 0.2 to 2 wt. % and particularly preferably of 0.4 to 1.2 wt. %, based on 100 parts by weight of monomer.

When preparing the branched copolymers according to the invention, it is important for the chain regulators to be added (either individually or in a mixture with one another) in the staged manner described earlier.

Whatever the case may be, the emulsion polymerization has to be controlled with the aid of the chain regulators in such a way that the copolymers based on unsaturated nitriles and conjugated dienes, according to the invention, are obtained with the appropriate chain branching.

It is also important for the final conversion to be at least 80%, preferably at least 85%, based on the total amount of monomers used.

The chain branching of the copolymers according to the invention is determined by the Δδ_{B} value according to the following method:

The copolymer according to the invention is characterized in an RPA 2000 rheometer (from Alpha-Technologies) at a measurement temperature of 100° C. over a frequency range of 0.01 to 33.3 Hz and an amplitude of 0.5° (=7%). The Δδ_{B} value is then calculated according to the following formula:

Δδ_{B}=δ(0.0167 Hz)−δ(15.92 Hz)

δ being the loss angle of the rubber sample.

Prior to the measurement, the sample is heated for 5 minutes at 100° C. in the rheometer and homogenized.

The solubility of the copolymers according to the invention is determined by dissolving them in methyl ethyl ketone at 20° C., filtering the solution and removing the solvent by distillation without leaving a residue. The undissolved portion is then dried to constant weight at temperatures of approx. 80° C., optionally under vacuum, and determined by weighing. The solubility (gel content) is then calculated as follows: solubility (gel content)=amount of undissolved polymer/total amount of polymer×100 (%).

The Mooney viscosities are determined according to DIN 53 523 and the content of bonded unsaturated nitrile is determined by the Kjeldahl method analogously to EP 0 779 300 B1, p.8.

The molecular weight distribution of the branched copolymers obtained according to the invention is determined by the thermal field flow fractionation method. The determination was carried out using a Channel T-100 ThFFF apparatus from Wyatt, in which the polymer obtained is separated into fractions according to molecular weight. The molecular weights of the fractions were separated and determined by virtue of the different temperatures of the dividing walls of the separating channel. The temperature difference between the dividing walls was 60° C. at the beginning of the determination and 0° C. at the end of the determination, said temperature difference decreasing exponentially with time. The fall-off factor was 15. The solvent used to determine the molecular weights was tetrahydrofuran. The flow rate of the polymer dissolved in tetrahydrofuran was adjusted to 0.2 ml/min. The polymer fractions were determined by the combined application of light scattering, UV absorption at 254 nm and determination of the refractive index.

The invention also provides the use of the branched copolymers based on unsaturated nitriles and conjugated dienes, prepared according to the invention, for the preparation of corresponding hydrogenated copolymers. The hydrogenation of the copolymers according to the invention is conventionally effected in the presence of a suitable catalyst and in the presence of hydrogen, for example as described in DE-A 253 913, EP-A 213 422 A, EP-A 174 076, EP-A 134 023 and U.S. Pat. No. 4,581,417.

The hydrogenation is stopped when the desired residual double bond content has been reached.

The nitrile content, Mooney viscosity, chain branching and solubility of the hydrogenated branched copolymers obtained correspond to those of the original unsaturated copolymers used.

The hydrogenation is preferably carried out until the residual double bond content ranges from 0 to 30%, preferably from 0.1 to 12%, based on the content of conjugated dienes used in the polymerization.

The residual double bond content of the resulting hydrogenated copolymers is determined in conventional manner according to ASTM D 5670-95.

Both the unhydrogenated and the hydrogenated branched copolymers can be used for the production of all kinds of mouldings by the injection moulding or extrusion process. The copolymers can also be used for improving the flowability of elastomers such as copolymers based on unsaturated nitrile and conjugated diene, and their hydrogenated secondary products (NBRs and HNBRs), ethylene/vinyl acetate copolymers, polyacrylates, ethene/acrylate elastomers, fluorine polymers and polyvinyl chloride. The copolymers according to the invention are preferably used, in both hydrogenated and unhydrogenated form, for incorporation into NBRs and HNBRs.

### EXAMPLES

General method of preparing branched copolymers based on unsaturated nitriles and conjugated dienes:

A continuously operated reactor cascade (5 reactors) is charged with 166 parts by weight of water per 100 parts by weight of monomer, 2 parts by weight of potassium fatty acid salt (emulsifier), 34.5 parts by weight of acrylonitrile, 65.5 parts by weight of butadiene, 0.0071 part by weight of iron(II) sulfate and some of the 2,2′,4,6,6′-pentamethylheptane-4-thiol molecular weight regulator (0.15 part by weight). The reaction is started by the addition of 0.322 part by weight of p-menthane hydroperoxide in the form of an emulsion polymerization at 13° C.

As soon as the conversion has reached 45%, the remainder of the molecular weight regulator (0.74 part by weight) is added and polymerization is continued until the desired final conversion of 87% has been reached. The ratio of the amount of molecular weight regulator added at the beginning to the amount of molecular weight regulator added later is 1:4.9. The polymerization is stopped by the addition of 0.15 part by weight of diethylhydroxylamine. Unreacted monomers are then removed from the reaction solution by heating to 50° C. and applying a reduced pressure of 600 mbar. 0.3 wt. % of an alkylated bisphenol antioxidant is added to the polymer contained in said solution.

The polymer is precipitated by the addition of sulfuric acid, separated off, washed thoroughly with water and alkali and then dried at 130° C.

### COMPARATIVE EXAMPLE

The polymerization is carried out with the stated molecular weight regulator according to the procedure outlined above, except that, in contrast to the Example according to the invention, 0.39 part by weight of the molecular weight regulator is added at the beginning and 0.17 part by weight of the molecular weight regulator is added when the conversion has reached 45%. Polymerization is continued until the conversion has reached 75%, based on the monomers used. After the polymerization has been stopped, the polymer is isolated in the manner described above. The ratio of the initial amount of molecular weight regulator to the amount of molecular weight regulator added later is 2.3:1.

Table 1 below shows the individual data for the polymerization reaction.

TABLE 1

| | Example 1 | Comparative Example |
|---|---|---|
| | [phm] | [phm] |
| Water | 166 | 166 |
| Butadiene | 65.5 | 65.5 |
| Acrylonitrile | 34.5 | 34.5 |
| Molecular weight regulator | 0.15 | 0.39 |
| (initial amount) | | |
| Remaining amount | 0.74 | 0.17 |
| at conversion [%] | 45 | 45 |
| Ratio of initial to remaining | 1:4.9 | 2.3:1 |
| amount of regulator | | |
| Fe(II)SO₄ | 0.0071 | 0.0076 |
| p-Menthane hydroperoxide | 0.0322 | 0.0239 |
| Emulsifier (K fatty acid salt) | 2 | 2 |
| Polymerization time [min] | 720 | 720 |
| Polymerization temperature | 13 | 13 |
| [° C.] | | |
| Conversion | 87 | 75 |

Table 2 lists the properties of the polymers obtained according to the invention and the polymers not obtained according to the invention:

TABLE 2
Polymer properties

| Example | | 1 | 2 (Comparison) |
|---|---|---|---|
| Polymer | | Branched NBR | Linear NBR |
| Residual double | [%] | 100 | 100 |
| bond content | | | |
| ACN | [%] | 34.7 | 34.7 |
| ML 1 + 4(100° C.) | [MU] | 31 | 29 |
| Δδ_{B} | [°] | 7.6 | 25.4 |

The molecular weights of the copolymers according to the invention and the copolymers not according to the invention, determined by thermal field flow fractionation, are shown in Table 3 below.

TABLE 3
Molecular weights determined by thermal field flow fractionation (ThFFF)

| | Molecular weights | | | | Fractions | | | |
|---|---|---|---|---|---|---|---|---|
| | ACN | M_{w}/Mₙ | Mₙ | M_{w} | M_{w} < 10⁵ | 10⁵ < M_{w} < 10⁶ | 10⁶ < M_{w} < 10⁷ | M_{w} < 10⁷ |
| Ex. | [wt. %] | [] | [g/mol] | [g/mol] | [%] | [%] | [%] | [%] |
| 1 | 34.7 | 85 | 58,000 | 4,950,000 | 62.4 | 25.7 | 3.1 | 8.8 |
| 2 | 34.7 | 3 | 67,000 | 200,000 | 56 | 41 | 2.7 | 0 |

Determination of the Processability of the Copolymers According to the Invention

a) Determination of the Mixing Viscosity of the Branched NBRs According to the Invention (Example 1):

To determine the mixing viscosity of the NBR copolymer obtained according to the invention, this copolymer was mixed with the components shown in Table 4 below. For comparison, a linear NBR (Comparative Example 2) was mixed with the same components.

TABLE 4

| | | |
|---|---|---|
| Branched NBR (Example 1) or linear NBR (Example 2) | 100 | phr |
| Sulfur | 0.35 | phr |
| Zinc oxide | 5 | phr |
| 2-Mercaptobenzimidazole (Vulkanox ® MB2, Bayer AG) | 1.5 | phr |
| 2,2,4-Trimethyl-1,2-dihydroquinoline (polymerized) = | 1.5 | pbr |
| Vulkanox ® HS (Bayer AG) | | |
| Moderately active furnace black N550 | 30 | phr |
| Inactive furnace black N772 | 50 | phr |
| Plasticizer(*) (Vulkanol ® OT, Bayer AG) | 10 | phr |
| Stearic acid | 0.3 | phr |
| N-tert-Butylbenzothiazylsulfenamide | 1.5 | phr |
| Tetramethylthiuram disulfide | 1.5 | phr |
| Vulcanization retarder (Vulkalent ® E, Bayer AG) | 1 | phr |

To prepare the mixture, the components listed in Table 4 were mixed in a closed mixer under the same conditions.

The copolymers were mixed in a GK 90 closed mixer from Werner & Pfleiderer at an initial temperature of 50° C. in the closed mixer. The polymer was first plasticized for approx. 30 seconds, after which the components indicated in Table 4 were added gradually. Mixing was continued for a total of 3.5 minutes. After the mixture had cooled, the mixing viscosity was determined in conventional manner according to DIN 53 523.

The resulting Mooney viscosities of the branched NBR according to the invention and the linear NBR not according to the invention are listed in Table 5.

TABLE 5

| | Linear NBR | Branched NBR |
|---|---|---|
| ML 1 + 4/100° C. (MU) | 63 | 40 |

As can be seen from Table 5, the mixing viscosity of the NBR according to the invention is substantially lower than that of the linear NBR not according to the invention. This is surprising in that, according to Table 2, the Mooney viscosities of the NBR according to the invention and the NBR not according to the invention are practically comparable.

b) Determination of the Processability of the NBR According to the Invention in the Injection Moulding Process

To determine the processability of the NBR according to the invention, the mixture described above was examined in a so-called rheovulcameter test, which was carried out with a rheovulcameter from Göttfert, Germany, at a plunger/nozzle temperature of 100° C., at a mould temperature of 180° C., for an injection time of 20 seconds, at a pressure of 70 bar and for a preheating time of 100 seconds. In this test, the mixture is passed through a capillary at the indicated pressure and injected into a vulcanization mould. The vulcanization mould is temperature-controlled so that the injected compound vulcanizes in the mould during the filling process, but remains in the unvulcanized state in the capillary.

For evaluation, the amount of injected compound in the mould is determined (mould filling), larger amounts (higher degrees of filling) representing a better processability of the mixture.

Table 6 below compares the branched NBR of Example 1 according to the invention with the linear NBR of Example 2 not according to the invention.

TABLE 6

| | Linear NBR | Branched NBR |
|---|---|---|
| Mould filling (%) | 34% | 55% |

c) Production of Vulcanizates

The vulcanizates are based on the copolymers according to the invention and were produced by heating the rubber mixture indicated above for 10 minutes in a hot press at 160° C. After this time, the product was cooled and the physical properties of the resulting vulcanizate were determined. The strength, elongation at break and tensile stress were determined according to DIN 53 430, the hardness was determined according to DIN 53 519 and the compression set was determined according to DIN 53 517. The values found are shown in Table 7 below.

TABLE 7

| | Linear NBR | Branched NBR |
|---|---|---|
| Strength (Mpa) | 18 | 19 |
| Elongation at break (%) | 470 | 505 |
| Tensile stress at 300% elongation (Mpa) | 14.4 | 13.75 |
| Hardness (Shore A) | 72 | 67 |
| Compression set | | |
| 70 h/23° C. (%) | 7 | 7 |
| 70 h/100° C. (%) | 34 | 37 |

As is apparent from Table 7, the branched copolymers according to the invention can be used to produce vulcanizates whose essential physical properties are comparable to those of the conventional linear copolymers.

1. Branched copolymers based on unsaturated nitriles and conjugated dienes, characterized in that the content of bonded unsaturated nitrile is 15 to 50 wt. %, the Mooney viscosity ranges from 15 to 150 MU [ML 1+4/100° C.], the chain branching ranges from 0 to 20° (determined by the Δδ_{B} value) and the solubility is ≧85 wt. % (measured in methyl ethyl ketone at 20° C.).

2. Process for the preparation of the branched copolymers according to claim 1, characterized in that the monomers used are polymerized in emulsion in conventional manner in the presence of a chain regulator, the chain regulator being added in at least two stages and the conversion being at least 80%.

3. Process according to claim 2, characterized in that 5 to 65% of the chain regulator is added to the mixture to be polymerized before polymerization begins and the remainder of the chain regulator is added when the conversion has reached 5 to 80%, based on the total amount of monomers used.

4. Use of the copolymers according to claim 1 for the preparation of hydrogenated copolymers based on unsaturated nitriles and conjugated dienes (HNBRs) for the production of all kinds of mouldings by the injection moulding or extrusion process and for improving the flowability of elastomers.

5. Branched copolymers according to claim 1, characterized in that they have been hydrogenated in conventional manner, the residual double bond content ranging from 0 to 30%, as determined according to ASTM D 5670-95.
